(19) United States
(12) Patent Application Publication
(10) Pub. No.: US 2014/0071798 A1
(43) Pub. Date: Mar. 13, 2014

(54) MULTILAYER INFORMATION RECORDING MEDIUM, AND INFORMATION PLAYBACK METHOD AND INFORMATION RECORDING METHOD EMPLOYING SAME

(71) Applicant: Takahiro Kurokawa, Tokyo (JP)

(72) Inventor: Takahiro Kurokawa, Tokyo (JP)

(73) Assignee: HITACHI CONSUMER ELECTRONICS CO., LTD., Tokyo (JP)

(21) Appl. No.: 14/110,714

(22) PCT Filed: Mar. 7, 2012
(86) PCT No.: PCT/JP2012/001542

§ 371 Date: Nov. 27, 2013

(30) Foreign Application Priority Data
Apr. 11, 2011 (JP) 2011-086921

(51) Int. Cl. G11B 7/007

(52) U.S. Cl. CPC G11B 7/007
USPC 369/44.26

(57) ABSTRACT

The purpose of the present invention is to minimize increase in the number of types of medium control information, and increase in time required for OPC, in association with a greater number of recording layers in a multilayer optical information recording medium. Provided is a multilayer optical information recording medium having two or more recording layers, the multilayer optical information recording medium characterized in that the recording layers are classified into layer groups that are fewer in number than the number of recording layers, each of the layer groups so classified being assigned medium control information that is shared within the layer group, and the medium control information assigned to each layer group being pre-registered in an administrative domain.

### TECHNICAL FIELD

The present invention relates to an optical information recording medium and an information recording and playback method. In particular, the present invention relates to media control information written on a multilayer optical information recording medium and a recording and playback control technique using the media control information.

### BACKGROUND ART

Optical information recording media represented by optical discs such as a DVD (Digital Versatile Disc) and a BD (Blu-ray Disc) have a recording layer for recording information in the medium, and information recording is conducted by irradiating the top of the recording layer with light and changing the reflectance of light. Furthermore, playback of recorded information is conducted by irradiating the top of the recording layer with light and detecting a change of reflectance caused by information recording.

In optical discs, the so-called multilayer technique which increases the information recording capacity by providing a plurality of recording layers in one medium is developed. For example, in BD-RE and BD-R standards, a medium having one recording layer and a medium having two recording layers are stipulated. Furthermore, recently, standards of optical discs having three or four recording layers based on the BD format have also been made. In this way, attempts to increase the number of recording layers are now continued at the present time as well. Furthermore, a technique of a multilayer optical disc medium including a plurality of recording layers having a groove-less structure that doesn't have a guide groove for tracking servo and a guide layer exclusively for tracking independent of the recording layers is also proposed.

In general, media control information for conducting information recording and playback on a medium is written in advance in an optical disc medium. As such information, there is, for example, physical format information (PFI) in DVD-RAMs, DVD-RWs, DVD+RWs, DVD-Rs and DVD+Rs. Furthermore, in the case of an optical disc described in Patent Literature 1, disc information (DI) is equivalent to the media control information.

Media control information in conventional optical discs will now be described by taking the DI in Patent Literature 1 as an example. FIG. 1 is a diagram illustrating a data structure of a conventional optical disc medium schematically. A lead-in area 101, a data area 102, and a lead-out area 103 are disposed in the optical disc medium in order from an inner circumference. Media control information 104 is written in the lead-in area 101. Media control information units 0, 1, 2, . . . , N−1 classified into N kinds in accordance with combinations of a recording layer, a recording speed, and a recording pulse kind are written in the media control information 104 in order. In the present specification, one set of media control information given by classifying according to conditions in this way is referred to as media control information unit. By the way, in the case of a two-layer disc having two recording layers, media control information having the same contents and corresponding to two layers is written in each of the recording layers and media control information corresponding to two layers can be acquired from either of the recording layers.

A structure of the media control information unit in the conventional optical disc will now be described. FIG. 2 is a diagram illustrating a structure of the media control information unit in an optical disc described in Patent Literature 1. One media control information unit is formed of data of 112 bytes in total including header information 201, recording and playback control information 202, and footer information 203. The header information 201 includes the number of media control information units, a recording pulse classification used at the time of recording, or information of a recording layer to which the media control information unit is applied, and the like. Contents of the recording and playback control information 202 are divided into media information 204, playback power setting information 205, recording power setting information 206, and recording pulse setting information 207, and parameters concerning the respective items are written in them. For example, as a parameter concerning the playback power setting information 205, there is maximum playback power information which specifies an upper limit value of power with which the medium is irradiated when playing back information. As parameters concerning the recording power setting information 206, there are parameters for executing OPC (Optimum Power Control) which will be described later. Furthermore, as parameters concerning the recording pulse setting information 207, there are parameters that specify timing of respective pulses included in recording pulses.

The OPC in the optical disc will now be described. The OPC means a series of procedures for finding optimum recording power according to differences in conditions such as a recording medium, a recording layer, a recording and playback device, and an ambient temperature. Specifically, trial writing is conducted in a predetermined area on a medium while changing recording power step by step, and optimum recording power is derived on the basis of a relation between the recording power and an evaluated value obtained from a played back signal.

As an adjustment method of the recording power using trial writing, OPC in a κ system using a relation between the recording power and modulation is recommended in, for example, BD-RE and BD-R standards. In this method, calculation of an optimum recording power P_{WO} is conducted by using a relation between recording power P_{W} and a modulation m, and specified recording power P_{IND}, a coefficient target value κ, a coefficient ρ and the like which are predetermined parameters. These parameters are recorded in advance on the medium as the recording power setting information in the media control information described above. First, a predetermined signal is recorded in a predetermined area of an optical disc by using recording power P_{W} of a plurality of kinds in the vicinity of the specified recording power P_{IND}, and the recorded signal is played back. As a result, the modulation m which is a value obtained by dividing an amplitude of a played back signal by an upper envelope level is acquired in association with the recording power P_{W}. Subsequently, linear approximation is conducted on a relation between an evaluated value m*P_{W} and the recording power P_{W} in a predetermined power range around P_{IND}. A value of the recording power P_{W} in a case where the evaluated value m*P_{W} becomes zero is calculated as recording power threshold Pₜₕᵣ. In a relation between a target recording power P_{target}=κ*Pₜₕᵣ obtained by multiplying the calculated Pₜₕᵣ by the coefficient target value κ and the recording power P_{W}, recording power P_{W} satisfying P_{target}=P_{W} is determined as optimum target recording power P_{targeto}. A value obtained by multiplying the optimum target recording power P_{targeto} by the coefficient ρ is determined as optimum recording power P_{WO}.

Furthermore, as another form of OPC recommended in the standards of BD-R, there is a β system. In this method, supposing that an upper envelope level of an AC-coupled played back signal is A1 and a lower envelope level thereof is A2, recording power that causes asymmetry β represented by β=(A1+A2)/(A1−A2) to coincide with a predetermined value is determined as optimum recording power.

### CITATION LIST

### Patent Literature

Patent Literature 1: JP-A-2006-313621

### SUMMARY OF INVENTION

### Technical Problem

In the conventional multilayer optical information recording medium, there are following problems caused as the number of recording layers increases.

A first problem is increase of the total data amount of the media control information caused by increase of kinds of the media control information units. In the conventional optical disc described in Patent Literature 1, a media control information unit is given for every combination of the recording layer, recording speed, and recording pulse classification. If the number of recording layers increases, therefore, the number of kinds of media control information units increases in proportion to the number of recording layers and the total data amount of media control information increases. In the optical disc described in Patent Literature 1, the same media control information unit is written in a predetermined area on the medium a plurality of times repetitively as described above. This is considered to be conducted in order to improve tolerance to degradation causes, such as scratches and fingerprints, of the optical disc. If the kinds of the media control information units increase, however, the number of times of repetition decreases, resulting in lowered reliability of media control information data. In addition, if kinds of media control information units increases, the number of parameters increases correspondingly, and consequently burden for determining those values increases in the medium manufacturer.

A second problem is the increase of time required for OPC. In general, the parameters for executing OPC are different every recording layer. In the conventional optical disc described, for example, in Patent Literature 1, therefore, a media control information unit is given for every recording layer. As a result, the parameter for executing the OPC is also given every recording layer. And for determining recording power for some recording layer, it is necessary to execute the OPC in the recording layer. For determining recording power for all recording layers, therefore, it is necessary to execute the OPC as many times as the number of recording layers. If the number of recording layers increases, therefore, the time required for the OPC increases and time required for setup processing of the recording and playback device increases. In other words, time required from a medium is inserted into the recording and playback device until the medium becomes usable, or time required from a recording command is given to the recording and playback device until recording is actually started increases and convenience in use by a user is hampered.

A first object of the present invention is to provide means for suppressing the increase of the number of kinds of media control information units caused by the increase of the number of recording layers in order to solve the first problem.

Furthermore, a second object of the present invention is to provide means for suppressing the increase of OPC required time caused by the increase of the number of recording layers in order to solve the second problem.

### Solution to Problem

In the present invention, the following means are used to achieve the objects.

(1) In a multilayer optical information recording medium including at least three recording layers, the recording layers are classified into layer groups that are fewer in number than the recording layers, media control information common in a layer group is provided for every layer group generated by the classification, and the media control information provided every layer group is recorded in advance in a predetermined area on the multilayer optical information recording medium.

In the present configuration, a plurality of recording layers included in a multilayer optical information recording medium are classified into several groups (hereafter referred to as layer groups), and a media control information unit given for every recording layer in the conventional optical disc is given for every layer group. Since the number of layer groups is set to be less than the number of recording layers, the kinds of media control information units can be decreased as compared with the conventional optical disc. The media control information unit is given at least for every layer group. However, it is also possible to add conditions such as, for example, recording speed and recording pulse classification as shown in FIG. 9 and give a media control information unit every combination of them. By the way, it is necessary to determine a way of classification into layer groups (such as the number of layer groups and assignment of recording layers to each layer group) to be able to suitably conduct recording and playback on respective recording layers even if common media control information is used for every same layer group. Owing to the present configuration, it is possible to suppress increase of the data quantity of the media control information caused by increase of the number of recording layers. As a result, the first object in the present invention is achieved.

(2) In addition, for every layer group, parameters for specifying maximum playback power with respect to each of the recording layers belonging to the layer group are included in the media control information.

The present configuration further concretizes contents of the media control information in the configuration of (1). The maximum playback power means an upper limit of the power of light with which the medium is irradiated at the time of information playback. The maximum playback power is specified mainly by a manufacturer of the medium in order to prevent a recorded track from being degraded by light irradiation. The maximum playback power is determined, for example, to cause playback signal qualities such as amplitude, jitter, and errors to satisfy criteria after a predetermined number of times of playback. In the present configuration, every layer group, parameters for specifying maximum playback power with respect to each of recording layers belonging to the layer group are given and written in media control information. Even if the data quantity in the media control information is reduced, therefore, it becomes possible to play back information with suitable playback power in the recording and playback device. A more desirable configuration is obtained in achieving the first object in the present invention.

(3) In addition, the recording layers are respectively provided with consecutive integer layer numbers in order from back when viewed from a light incidence plane of the multilayer optical information recording medium or in order from front. The maximum playback power for each of the recording layers is given by a polynomial function of the layer number. Parameters for specifying maximum playback power for each of the recording layers are parameters indicating respective coefficients of the polynomial function of the layer number. And the parameters are set every layer group.

The present configuration further concretizes the parameters for specifying the maximum playback power in the configuration of (2). In the present configuration, the recording layers are provided with consecutive integer layer numbers such as, for example, 0, 1, 2, . . . in order from a back recording layer when viewed from a light incidence plane or in order from a front recording layer. The maximum playback power for each of the recording layers is given by a polynomial function (mth order function; where m is an integer of at least 0) of the layer number. In other words, when the layer number is n, maximum playback power Prₘₐₓ(n) for the nth recording layer is given by the following MATH. 1.

[MATH. 1]

Prₘₐₓ(n)=c₀+c₁n+c₂n²+Λ+cₘ₋₁n^{m-1}+cₘn^{m} MATH. 1

Here, cₓ is a coefficient of an xth order term of n. In other words, the present configuration approximates a relation between the layer number and actual maximum playback power by using a polynomial function, and states parameters indicating c₀, c₁, c₂, . . . , Cₘ₋₁, Cₘ for specifying the polynomial function, in the media control information. For example, in a case where a second order function is used as the polynomial function, parameters indicating c₀, c₁ and c₂ are written in the media control information. The set of coefficients c₀, c₁, c₂, . . . , cₘ₋₁, cₘ is written at least for every media control information unit classified according to the layer group. If the layer group differs, therefore, values of the respective coefficients differ. In the present configuration, a polynomial function is used. Even if the relation between the layer number and the maximum playback power is complicated, therefore, the error between the value of the polynomial function and the actual value of the maximum playback power can be made small if a polynomial function that is high in degree is used. In a case where the medium having the present configuration is used, a maximum playback power for a recording layer (playback object layer) to be played back can be calculated by referring to a media control information unit corresponding to a layer group to which the playback object layer belongs, specifying a polynomial function by using respective coefficients written in the media control information unit, and substituting a layer number of the playback object layer into the specified polynomial function. In other words, maximum playback power for each of the recording layers can be found from the media control information given for every layer group. Even if the data quantity in the media control information is reduced, therefore, it becomes possible to play back the information with respect to each of the recording layers with suitable playback power. In achieving the first object in the present invention, therefore, a more desirable configuration is obtained.

(4) In the multilayer optical information recording medium of (3), the polynomial function of the layer number is a first order function of the layer number.

The present embodiment further concretizes the polynomial function of the layer number giving maximum playback power in the configuration of (3). In the present configuration, maximum playback power for each of the recording layers is given by a first order function of the layer number. In other words, when the layer number is n, maximum playback power Prₘₐₓ(n) for the nth recording layer is given by the following MATH. 2.

[MATH. 2]

Prₘₐₓ(n)=c₀+c₁n MATH. 2

Here, c₀ and c₁ are coefficients of zero-th and first order terms of n. In other words, the present configuration approximates the relation between the layer number and the actual maximum playback power by using a first order function, and states parameters indicating the coefficients c₀ and c₁ for specifying the first order function, in the media control information. The set of coefficients c₀ and c₁ is written at least for every media control information unit classified according to the layer group. If the layer group differs, therefore, values of the respective coefficients differ. In the present configuration, parameters for specifying the coefficients c₀ and c₁ of the first order function are written on the medium as a part of the media control information. Since the polynomial function is restricted to the first order function, information for specifying the first order function is only the coefficients c₀ and c₁, and is kept to a minimum required. The data quantity in the media control information can be reduced. Owing to the present configuration, a more desirable configuration is obtained in achieving the first object in the present invention.

The case where the relation is represented by a first order function has been described above. In a case where maximum playback power for all recording layers belonging to the same layer group is made the same, only a parameter indicating c₀ is written. In this case, it is possible to obtain an effect that the data quantity can be further reduced.

(5) In addition, parameters for executing OPC on each of the recording layers are included in the media control information.

The present configuration further concretizes contents of the media control information in the configurations of (1) to (4). In the present configuration, parameters for executing OPC on the recording layers are written in the media control information. Since parameters for executing OPC are given for every layer group, OPC is executed on recording layers belonging to the same layer group by using the same parameters. Furthermore, in the present configuration, the parameters for executing OPC are written in media control information. Owing to the present configuration, it becomes possible to record information on respective recording layers with optimum recording power, even if the data quantity of the media control information is reduced. In achieving the first object in the present invention, therefore, a more desirable configuration is obtained.

(6) In the multilayer optical information recording medium of (5), at least specified recording power for executing OPC of a κ system is included in the parameters for executing OPC, the recording layers are respectively provided with consecutive integer layer numbers in order from back when viewed from a light incidence plane of the multilayer optical information recording medium or in order from front, the specified recording power for each of the recording layers is given by a polynomial function of the layer number, and parameters for specifying specified recording power for each of the recording layers are parameters indicating respective coefficients of the polynomial function of the layer number and are set every layer group.

The present configuration further concretizes the parameters for executing OPC in the configuration of (5). Here, the specified recording power is a supposed value of optimum target recording power in the OPC of the above-described κ system, and is in a proportional relation to the supposed optimum recording power. In the present configuration, at least specified recording power is used as the parameters for executing OPC of the κ system in the configuration of (5), and specified recording power for each of the recording layers is given by a polynomial function (mth order function; where m is an integer of at least 0). In other words, when the layer number is n, specified recording power for an nth recording layer P_{IND}(n) is given by the following MATH. 3.

[MATH. 3]

P_{IND}(n)=c₀+c₁n+c₂n²+Λ+cₘ₋₁n^{m-1}+cₘn^{m} MATH. 3

Here, cₓ is a coefficient of an xth order term of n. In other words, the present configuration approximates a relation between the layer number and actual specified recording power by using a polynomial function, and writes parameters indicating c₀, c₁, c₂, . . . , cₘ₋₁, Cₘ for specifying the polynomial function, in the media control information. The set of coefficients c₀, c₁, c₂, . . . , cₘ₋₁, cₘ is written at least for every media control information unit classified according to the layer group. If the layer group differs, therefore, values of the respective coefficients differ. In the present configuration, a polynomial function is used. Even if the relation between the layer number and the specified recording power is complicated, therefore, the error between the value of the polynomial function and the actual value of the specified recording power can be made small if a polynomial function that has high in degree is used. In a case where the medium having the present configuration is used, a specified recording power for a recording layer (recording object layer) to be recorded can be calculated by referring to a media control information unit corresponding to a layer group to which the recording object layer belongs, specifying a polynomial function by using respective coefficients written in the media control information unit, and substituting a layer number of the recording object layer into the specified polynomial function. In other words, specified recording power for each of the recording layers can be found from the media control information given for every layer group. Even if the data quantity in the media control information is reduced, therefore, it becomes possible to execute OPC of the κ system with respect to each of the recording layers with suitable specified recording power. In achieving the first object in the present invention, therefore, a more desirable configuration is obtained.

(7) In the multilayer optical information recording medium of (6), the polynomial function of the layer number is a first order function of the layer number.

The present embodiment further concretizes the polynomial function of the layer number giving specified recording power in the configuration of (6). In the present configuration, specified recording power for each of the recording layers is given by a first order function of the layer number. In other words, when the layer number is n, specified recording power P_{IND}(n) for the nth recording layer is given by the following MATH. 4.

[MATH. 4]

P_{IND}(n)=c₀+c₁n MATH. 4

Here, c₀ and c₁ are coefficients of zero-th and first order terms of n. In other words, the present configuration approximates the relation between the layer number and the actual specified recording power by using a first order function, and states parameters indicating the coefficients c₀ and c₁ for specifying the first order function, in the media control information. The set of coefficients c₀ and c₁ is written at least every media control information unit classified according to the layer group. If the layer group differs, therefore, values of the respective coefficients differ. In the present configuration, parameters for specifying the coefficients c₀ and c₁ of the first order function are written on the medium as a part of the media control information. Since the polynomial function is restricted to the first order function, information for specifying the first order function is only the coefficients c₀ and c₁, and is kept to a minimum required. The data quantity in the media control information can be reduced. Owing to the present configuration, a more desirable configuration is obtained in achieving the first object in the present invention.

(8) In addition, parameters indicating timing of recording pulses are included in the media control information.

The present configuration further concretizes the configurations of (1) to (7). In the present configuration, parameters indicating timing of recording pulses are written in the media control information. Here, parameters indicating timing of recording pulses are parameters relating to timing of light emission of light with which the medium is irradiated when recording information. Specifically, the parameters are start time, end time or a time width of each of pulses included in a recording pulse train. In the present configuration, common recording pulse conditions are used for all recording layers belonging to the same layer group. Therefore, it is desirable to design recording characteristics of respective recording layers and a way of classifying the recording layers into layer groups in order to make it possible to record information in respective recording layers suitably in that case as well. Owing to the present configuration, it becomes possible to record information by using suitable recording pulses for respective recording layers, even if the data quantity of the media control information is reduced. In achieving the first object in the present invention, therefore, a more desirable configuration is obtained.

(9) In addition, parameters for specifying a layer group to which each of the recording layers belongs are included in the media control information.

The present configuration further concretizes the configurations of (1) to (8). For effectively utilizing the multilayer optical information recording medium according to the present invention in a recording and playback device, information as to which media control information unit should be applied to each of the recording layers becomes necessary. It is information for specifying a layer group to which each of the recording layers belongs. Relations between recording layers and layer groups may be determined in advance, for example, by standards of the medium or the like, or determined every medium by a supplier of the media. Supposing especially the case where the relations are determined arbitrarily by the media supplier, in the present configuration, parameters for specifying a layer group to which each of the recording layers belongs are recorded in advance on the medium as a part of media control information. Specifically, every media control information unit, parameters indicating a layer group and recording layers to which the media control information unit is applied are written. Owing to the present configuration, it becomes possible to apply suitable media control information to each of the recording layers in the recording and playback device, even if the data quantity of the media control information is reduced. In achieving the first object in the present invention, therefore, a more desirable configuration is obtained.

(10) In addition, all recording layers belonging to the same layer group are formed of the same film configuration.

The present configuration further concretizes the configurations of (4), (7) and (8). And the present configuration is one of means for implementing these configurations easily.

For implementing a state in which common recording pulse conditions are given for every layer group as in the multilayer optical information recording medium of (8), i.e., information can be recorded by using the same recording pulse conditions for all recording layers belonging to the same layer group, it is necessary to cause recording characteristics of those recording layers to become equivalent. In the present configuration, therefore, all recording layers belonging to the same layer group are made to have the same film configuration. Here, the film configuration means composition and thickness conditions of recording films and other films (guard films and reflection films) that form recording layers. Furthermore, the same film configuration means making the composition and film thickness nearly the same by making the film forming conditions same. The same film configuration does not mean that the composition and film thickness of completed films are completely the same. As a result, recording characteristics of all recording layers in a layer group become nearly equivalent. Accordingly, it becomes possible to record information suitably by using the same recording pulse conditions.

For implementing a state in which each of the maximum playback power and specified recording power is given by a first order function as in the multilayer optical information recording media of (4) and (7), it is necessary to make tolerance to playback light and sensitivity to recording light of those recording layers equivalent and make a power of light arriving at respective recording layers equivalent when the power of light incident on the medium is given according to a first order function of a layer number. This can also be implemented by providing all recording layers belonging to the same layer group with the same film configuration. This is because transmittance of each of recording layer having the same film configuration are equal as simple substance, and consequently under a condition that the transmittance is sufficiently large, medium incident light power that makes the power of light arriving at respective recording layers equivalent is approximately given by a first order function of a layer number.

FIG. 3 is a graph showing a relation between a layer number in a layer group having eight recording layers and a power of light to be incident on the layer group in order to cause the power of light arriving at a recording layer having the layer number to become 1 mW. Here, the recording layers are provided with layer numbers 0, 1, . . . , 7 in order beginning with a recording layer farthest from the light incidence plane. Furthermore, it is supposed that the recording layers have equal transmittance of 95% and intermediate layers (transparent layers between recording layers) cause no light loss. A solid line on the graph indicates a regression first order function (regression straight line) obtained from data points. According to this graph, an error between power given by the first order function and truly required power is 1.1% at most and very small. It is appreciated that incident light power can be approximated well by the first order function of the layer number in the present configuration.

By the way, in the medium of the present configuration, required power increases as the layer number becomes smaller, i.e., the recording layer is located nearer to the back when viewed from the light incident plane. When determining a way of classifying recording layers into layer groups, therefore, it is desirable to cause required power for every recording layer to be contained in a possible output range of a laser light source, for example, by making an optical absorption coefficient larger as the layer group is located nearer to the back.

Owing to the present configuration, it becomes possible to conduct recording and playback with suitable power for each of the recording layers even if the data quantity of the media control information is reduced, as described heretofore. In achieving the first object in the present invention, therefore, a more favorable configuration is obtained.

(11) An information playback method includes a process for reading out media control information corresponding to a layer group to which a playback object layer belongs, from a multilayer optical information recording medium including at least three recording layers, the recording layers being classified into layer groups that are fewer in number than the recording layers, media control information common in a layer group being given for every layer group generated by the classification, the media control information being recorded in advance in a predetermined area, parameters for specifying maximum playback power for each of the recording layers being included in the media control information; a process for extracting parameters for specifying maximum playback power for the playback object layer from the media control information read out; a process for specifying maximum playback power for the playback object layer by using the extracted parameters; and a process for playing back information of the playback object layer with playback power that does not exceed the specified maximum playback power.

The present configuration is an information playback method supposing use of the multilayer optical information recording medium of (2). Media control information is classified by layer group and recorded on the medium of (2). Parameters for specifying maximum playback power for each of the recording layers are included in contents of the media control information. In order to execute playback control on a playback object layer, media control information corresponding to a layer group to which the recording layer belongs is read out in the present configuration. Parameters for specifying maximum playback power are extracted from the media control information read out. Maximum playback power is calculated from the extracted parameters. Information in the playback object layer is played back with playback power having magnitude that does not exceed the maximum playback power. Owing to the present configuration, it becomes possible to play back information without degrading recorded tracks with respect to each of the recording layers even if the data quantity of the media control information is reduced. In achieving the first object in the present invention, a desirable configuration is obtained.

(12) In the information playback method of (11), the recording layers are respectively provided with consecutive integer layer numbers in order from back when viewed from a light incidence plane of the multilayer optical information recording medium or in order from front, the maximum playback power for each of the recording layers is given by a polynomial function of the layer number, and parameters for specifying maximum playback power for each of the recording layers are parameters indicating respective coefficients of the polynomial function of the layer number given for every layer group, the process for extracting parameters is a process for extracting parameters indicating respective coefficients of the polynomial function of the layer number for the playback object layer from the media control information read out, and the process for specifying maximum playback power is a process for specifying a polynomial function of the layer number by using the extracted parameters and calculating maximum playback power for the playback object layer by substituting the layer number of the playback object layer into the polynomial function of the layer number.

The present configuration further concretizes the information recording and playback method of (11). The present configuration is an information playback method supposing use of the multilayer optical information recording medium of (3). In the medium of (3), the recording layers are respectively provided with consecutive integer layer numbers, such as, for example, 0, 1, 2, . . . in order from a back recording layer when viewed from a light incidence plane or in order from a front recording layer. The maximum playback power for each of the recording layers is given by a polynomial function of the layer number. And parameters indicating respective coefficients of the polynomial function are written as a part of media control information. In order to execute playback control on a playback object layer, media control information corresponding to a layer group to which the recording layer belongs is read out, in the present configuration. Parameters given for every layer group to indicate respective coefficients of the polynomial function giving maximum playback power for each of the recording layers are extracted from the media control information read out. The polynomial function is specified from the extracted parameters. Maximum playback power is calculated by substituting the layer number of the playback object layer into the specified polynomial function. Information in the playback object layer is played back with playback power having magnitude that does not exceed the calculated maximum playback power. Owing to the present configuration, it becomes possible to play back information without degrading recorded tracks for each of the recording layers even if the data quantity of the media control information is reduced. In achieving the first object in the present invention, therefore, a more desirable configuration is obtained.

(13) An information recording method includes: a process for reading out media control information corresponding to a layer group to which a recording object layer belongs, from a multilayer optical information recording medium including at least three recording layers, the recording layers being classified into layer groups that are fewer in number than the recording layers, media control information common in a layer group being given for every layer group generated by the classification, the media control information given for every layer group being written in advance in a predetermined area on the multilayer optical information recording medium, and parameters for executing OPC on each of the recording layers being included in the media control information; a process for extracting parameters for executing OPC on the recording object layer from the media control information read out; a process for conducting the OPC in the recording object layer by using the extracted parameters and determining recording power for the recording object layer; and a process for recording information in the recording object layer by using the determined recording power.

The present configuration is an information recording method supposing use of the multilayer optical information recording medium of (5). Media control information is classified by the layer group and recorded on the medium of (5). Parameters for executing OPC on each of the recording layers are included in contents of the media control information. In order to execute recording control on a recording object layer, media control information corresponding to a layer group to which the recording layer belongs, is read out in the present configuration. Parameters for executing OPC are extracted from the media control information read out. The OPC is executed in the recording object layer by using the extracted parameters, and recording power for the recording object layer is determined. Information is recorded in the recording object with the determined recording power. Owing to the present configuration, it becomes possible to record information in each of the recording layers with suitable recording power even if the data quantity of the media control information is reduced. In achieving the first object in the present invention, therefore, a desirable configuration is obtained.

(14) In the information recording method of (13), at least specified recording power for executing OPC of a κ system is included in the parameters for executing OPC, the recording layers are respectively provided with consecutive integer layer numbers in order from back when viewed from a light incidence plane of the multilayer optical information recording medium or in order from front, the specified recording power for each of the recording layers is given by a polynomial function of the layer number, and parameters for specifying specified recording power for each of the recording layers are parameters indicating respective coefficients of the polynomial function of the layer number, the process for extracting parameters is a process for extracting parameters given for every layer group to indicate respective coefficients of the polynomial function, and the process for determining a recording power is a process for specifying the polynomial function from the extracted parameters, calculating a specified recording power for the recording object layer by substituting the layer number of the recording object layer into the specified polynomial function, executing OPC of the κ system in the recording object layer by using the calculated specified recording power, and determining a recording power for the recording object layer.

The present configuration further concretizes the information recording and playback method of (13). The present configuration is an information playback method supposing use of the multilayer optical information recording medium of (6). In the medium of (6), the recording layers are respectively provided with consecutive integer layer numbers, such as, for example, 0, 1, 2, . . . in order from a back recording layer when viewed from a light incidence plane or in order from a front recording layer. The specified recording power for each of the recording layers is given by a polynomial function of the layer number. And parameters indicating respective coefficients of the polynomial function are written as a part of media control information. In order to execute recording control on a recording object layer, media control information corresponding to a layer group to which the recording layer belongs is read out, in the present configuration. Parameters given for every layer group to indicate respective coefficients of the polynomial function giving a specified recording power for each of the recording layers are extracted from the media control information read out. The polynomial function is specified from the extracted parameters. A specified recording power is calculated by substituting the layer number of the recording object layer into the specified polynomial function. OPC of the κ system is executed in the recording object layer by using the calculated specified recording power and the extracted κ value and ρ value. A recording power for the recording object layer is determined. Information is recorded with the determined recording power. Owing to the present configuration, it becomes possible to record information with a suitable recording power for each of the recording layers, even if the data quantity of the media control information is reduced. In achieving the first object in the present invention, therefore, a more desirable configuration is obtained.

(15) In the information recording method of (14), the function of the layer number is a first order function of the layer number, and the information recording method includes a process for executing OPC in each of at least two recording layers among recording layers belonging to same layer group, and determining recording power for each of the recording layers, a process for calculating a regression first order function corresponding to relations between the layer number of the recording layer for which the OPC is executed and determined recording power, and a process for determining recording power for a different recording layer belonging to same layer group as the recording layer for which the OPC was executed, by substituting a layer number of the different recording layer into the calculated regression first order function.

The present configuration further concretizes the configuration of (14). The present configuration is an information recording method supposing use of the multilayer optical information recording medium of (7). In the medium of (7), design is conducted to give specified recording power for each of the recording layers by a first order function of the layer number. Here, optimum recording power for each of the recording layers also follows the first order function of the layer number. In the present configuration, therefore, OPC is executed on a plurality of recording layers belonging to the same layer group. A regression first order function (regression straight line) corresponding to a relation between the layer number and determined recording power is found. Recording power for each of remaining recording layers belonging to the same layer group is determined by substituting the layer number of the recording layer into the regression first order function. Here, effects of the present configuration are obtained on condition that the actual specified recording power can be approximated well by a first order function of the layer number. Therefore, it is desirable to determine the number of layer groups and recording layers belonging to each layer group to cause an error between actual specified recording power and power given by the first order function of the layer number to be contained in a predetermined range based on a requested power precision. As a result, recording power for every recording layer can be determined without executing OPC on every recording layer in the layer group. As compared with the conventional optical disc, therefore, required time for OPC can be shortened and the first and second objects in the present invention are achieved.

Furthermore, in the present configuration, recording power for every layer in a layer group can be determined if OPC is executed in one of recording layers in the layer group. Therefore, an effect equivalent to an increase of the size of the OPC area on the medium is obtained. This brings about an especially great advantage in media of incremental recording type in which overwriting of recording information cannot be conducted.

The information recording method of (13) to (15) includes a process for extracting parameters for specifying the specified recording power, a process for calculating specified recording power for each of the recording layers by using parameters for the recording layers, a process for executing OPC on one of the recording layers and determining recording power for the recording layer, a process for determining recording power for remaining recording layers in a layer group to which the recording layer belongs, on the basis of the determined recording power and the parameters, and a process for recording information with the determined recording power for each of the recording layers.

The present configuration further concretizes the configuration of (13). A ratio of a recording power determined by conducting OPC on one recording layer in a layer group to a recording power calculated by substituting the layer number into a polynomial function specified by parameters written in media control information is calculated. Recording power for each of remaining layers in the layer group is calculated by multiplying recording power for each of the recording layers calculated from the polynomial function by the ratio, Here, effects of the present configuration are obtained on condition that the actual specified recording power can be approximated well by a polynomial function of the layer number. Therefore, it is desirable to determine the number of layer groups and recording layers belonging to each layer group to cause an error between actual specified recording power and power given by the polynomial function of the layer number to be contained in a predetermined range based on a requested power precision. As a result, recording power for every recording layer can be determined without executing OPC on every recording layer in the layer group. As compared with the conventional optical disc, therefore, required time for OPC can be shortened and the first and second objects in the present invention are achieved.

### Advantageous Effects of Invention

According to the present invention, the increase of data amount of the media control information and increase of the OPC required time caused by the increase of the number of recording layers can be suppressed. As a result, it becomes possible to provide a large capacity, highly reliable multilayer optical information recording medium and an information recording and playback device using such a medium at low cost.

### BRIEF DESCRIPTION OF DRAWINGS

FIG. 1 is a diagram showing a data area in a conventional disc medium;

FIG. 2 is a diagram showing a configuration of a media control information unit in the conventional disc medium;

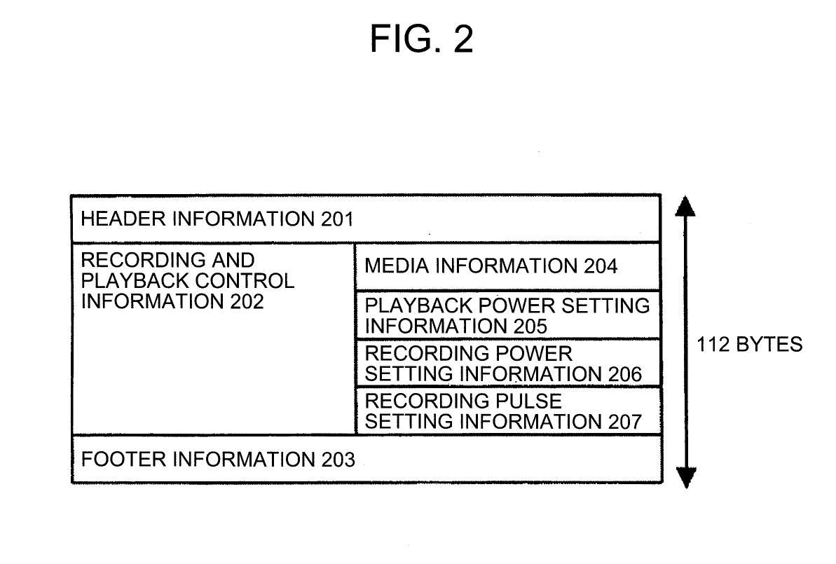

FIG. 3 is a graph showing a relation between a layer number and medium incident light power;

FIG. 4 is a diagram schematically showing a cross-sectional structure of a multilayer optical disc medium in an embodiment of the present invention;

FIG. 5 is a diagram showing a data structure of a multilayer optical disc medium in an embodiment of the present invention;

FIG. 6 is a diagram showing a configuration of a media control information unit in an embodiment of the present invention;

FIG. 7 is a diagram showing a configuration of an optical disc device in an embodiment of the present invention;

FIG. 8 is a diagram showing recording pulse waveforms of an N−1 write strategy in an embodiment of the present invention;

FIG. 9 is a diagram showing corresponding relations between media control information unit numbers and conditions under which the media control information unit numbers are applied, in an embodiment of the present invention;

FIG. 10 is a flow chart showing one form of an information playback procedure in an embodiment of the present invention;

FIG. 11 is a flow chart showing one form of an information recording procedure in an embodiment of the present invention;

FIG. 12 is a flow chart showing one form of an information recording procedure in an embodiment of the present invention;

FIG. 13 is a flow chart showing one form of an information recording procedure in an embodiment of the present invention; and

FIG. 14 is a diagram showing a method for calculating an optimum recording power in an embodiment of the present invention.

### DESCRIPTION OF EMBODIMENTS

Hereafter, embodiments of the present invention will be described with reference to the drawings.

### Embodiment 1

An example in which a multilayer optical information recording medium according to the present invention is applied to an optical disc will now be described. An optical disc medium in the present embodiment is based upon a physical format of incremental write type BD-R, and designed on the assumption that a light source having a wavelength of 405 nm and an objective lens having a numerical aperture of 0.85 are used. The disc has a diameter of 120 mm and a thickness of 1.2 mm.

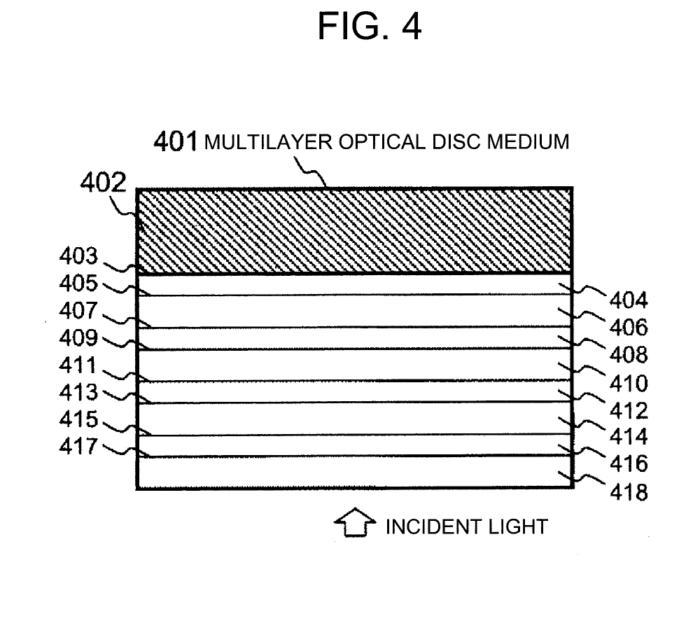

FIG. 4 is a diagram schematically showing a cross-sectional structure of a multilayer optical disc medium in the present embodiment. A multilayer optical disc medium 401 is formed by stacking a substrate 402, a zero-th recording layer 403, an intermediate layer 404, a first recording layer 405, an intermediate layer 406, a second recording layer 407, an intermediate layer 408, a third recording layer 409, an intermediate layer 410, a fourth recording layer 411, an intermediate layer 412, a fifth recording layer 413, an intermediate layer 414, a sixth recording layer 415, an intermediate layer 416, a seventh recording layer 417, and a cover layer 418 in order. The substrate 402 is a disc having a thickness of 1.05 mm, and polycarbonate resin is used as its material. On a surface of the substrate, a guide groove for causing an optical spot to track a determinate radial position is formed spirally with a pitch of 0.32 μm. Denoting a channel bit length by T, recording marks and recording mark spaces each 6 having a length in the range of 2T to 8T are formed along the guide groove. Here, the channel bit length is 74.5 nm, and the data capacity per recording layer becomes 25 GB under this condition. The zero-th recording layer 103 is formed next to the substrate 402. A recording layer has a structure in which a recording film is interposed between guard films. As a material of the recording film, a Bi—Ge nitride alloy which is an inorganic material is used. Recording is conducted by assigning bi-valued data “0” and “1” to a high reflectance portion and a low reflectance portion, respectively. Data is played back by utilizing a reflectance difference between them and distinguishing the bi-valued data “0” and “1.” The intermediate layers are formed to separate recording layers from each other. The intermediate layers 404, 408, 412 and 416 have a thickness of approximately 12 μm. The intermediate layers 406, 410 and 414 have a thickness of approximately 16 μm. An ultraviolet curing resin is used as their material. Finally, the cover layer 418 made of an ultraviolet curing resin having a thickness of 54 μm is formed to guard the surface of the disc.

The recording layers are classified into two layer groups. Three recording layers in the range of the zero-th recording layer to the second recording layer are classified into a zero-th layer group, and five recording layers in the range of the third recording layer to the seventh recording layer are classified into a first layer group. Recording layers belonging to the same layer group are formed of the same recording film and guard films. Tolerance to playback light, sensitivity to recording light, and optical characteristics such as transmittance, reflectance and absorbance are nearly equal in the layer group. Although the composition and film thickness of the recording films in all recording layers are the same, the guard films in the zero-th layer group are made to differ in thickness from the guard films in the first layer group, and the zero-th layer group differs from the first layer group in the above-described recording and playback characteristics and optical characteristics.

With a standard recording speed being set equal to 4.92 m/s, recording films in respective recording layers are designed to cope with recording at one-time speed, double speed, and quadruple speed according to N−1 write strategy and recording at quadruple speed according to Castle write strategy.

By the way, besides the items described above, the composition and film thickness of the recording film may be changed every layer group.

Description concerning a way of classifying the recording layers into the layer groups will now be complemented. If characteristics of all recording layers are made the same (the number of layer groups is set equal to one), intensity of return light from each of the recording layers becomes small as the recording layer is located in a deeper position, and consequently a lower limit of a signal-to-noise ratio (SN ratio) requested by the recording and playback device is not satisfied and it becomes impossible to ensure reliability of the playback of information in a recording layer located in a deeper position in some cases. In that case, recording layers which are insufficient in SN ratio are classified into a different layer group and the recording layers belonging to the different layer group are made large in reflectance. In the present embodiment, the recording layers belonging to the zero-th group located in a deeper position are made larger in reflectance than the recording layers belonging to the first layer group. As a result, in both the zero-th recording layer which is the deepest layer in the zero-th layer group and the third recording layer which is the deepest layer in the first layer group, a predetermined return light intensity can be ensured. The method described heretofore is also the same in cases where the number of recording layers is not eight. In a case where the number of recording layers is further increased, the number of layer groups is increased as the occasion may demand.

### Embodiment 2

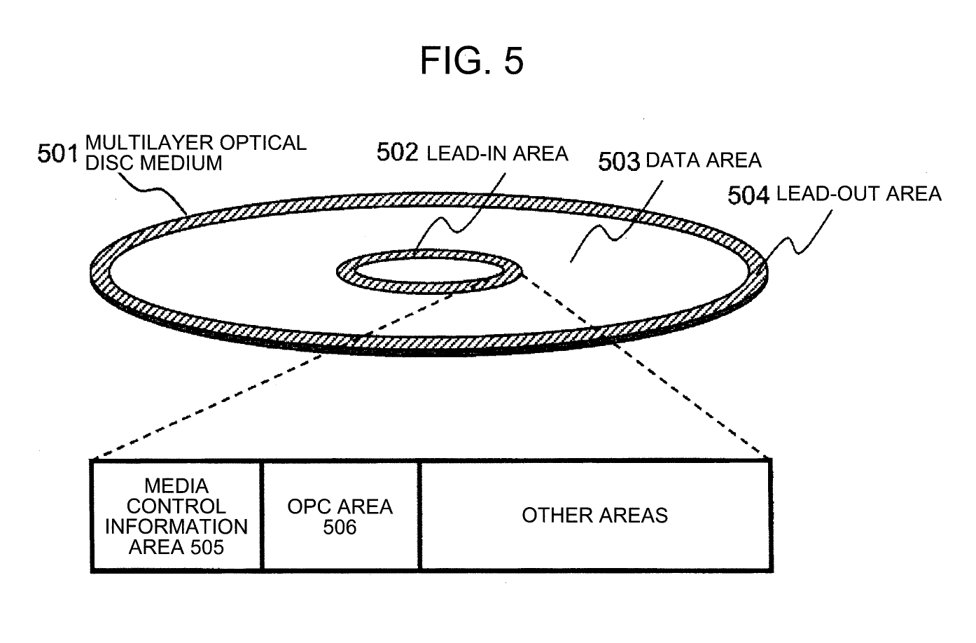

A configuration of the media control information in the present invention will now be described. FIG. 5 is a diagram showing a data structure of a multilayer optical disc medium in the present invention. Data in each of the recording layers of the multilayer optical disc medium 501 is formed of a lead-in area 502, a data area 503, and a lead-out area 504 in order from the inner circumference side. The lead-in area 502 includes a media control information area 505 in which media control information is written, an OPC area 506 on which recording power learning is conducted, and other areas.

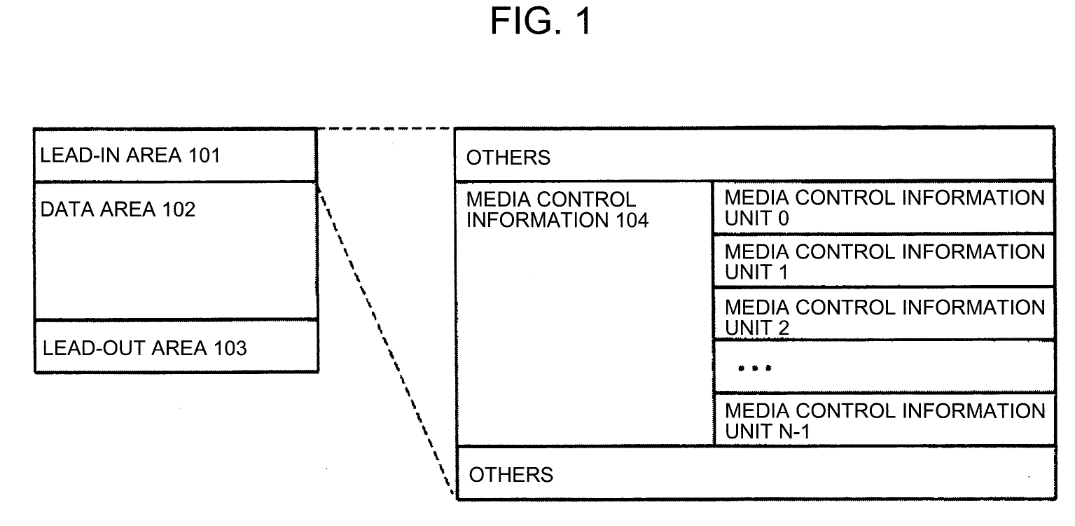

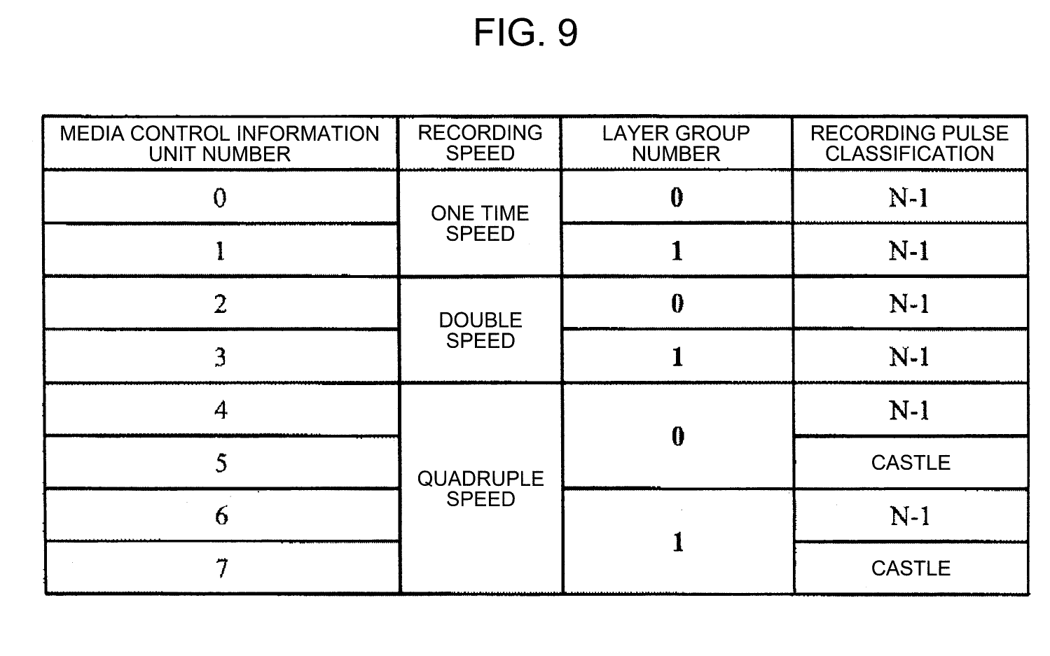

Details of the media control information written in the media control information area 505 will now be described. The structure of the media control information is basically the same as that in the conventional optical disc shown in FIG. 1. The media control information 104 is written in the lead-in area 101. The media control information 104 includes twelve media control information units respectively given according to combinations of the recording speed, the layer group, and the recording pulse classification. FIG. 9 is a diagram showing corresponding relations between media control information unit numbers and conditions under which the media control information unit numbers are applied, in the present embodiment. Media control information units are first classified in an ascending order according to the recording speed, then classified in an ascending order according to the layer group, and finally classified according to the recording pulse classification. The recording speeds that the medium in the present embodiment copes with are of three kinds, i.e., one-time speed, double speed, and quadruple speed. The layer groups are of two kinds: the zero-th layer group and the first layer group. As for the recording pulse classification, there is one kind, i.e., the N−1 write strategy, in the case of the one-time speed and the double speed. In the case of the quadruple speed, there are two kinds, i.e., the N−1 write strategy and the Castle write strategy. As a result, media control information units of eight kinds in total are given. Such a set in the range of media control information unit 0 to media control information unit 7 is written repetitively in the media control information area 505.

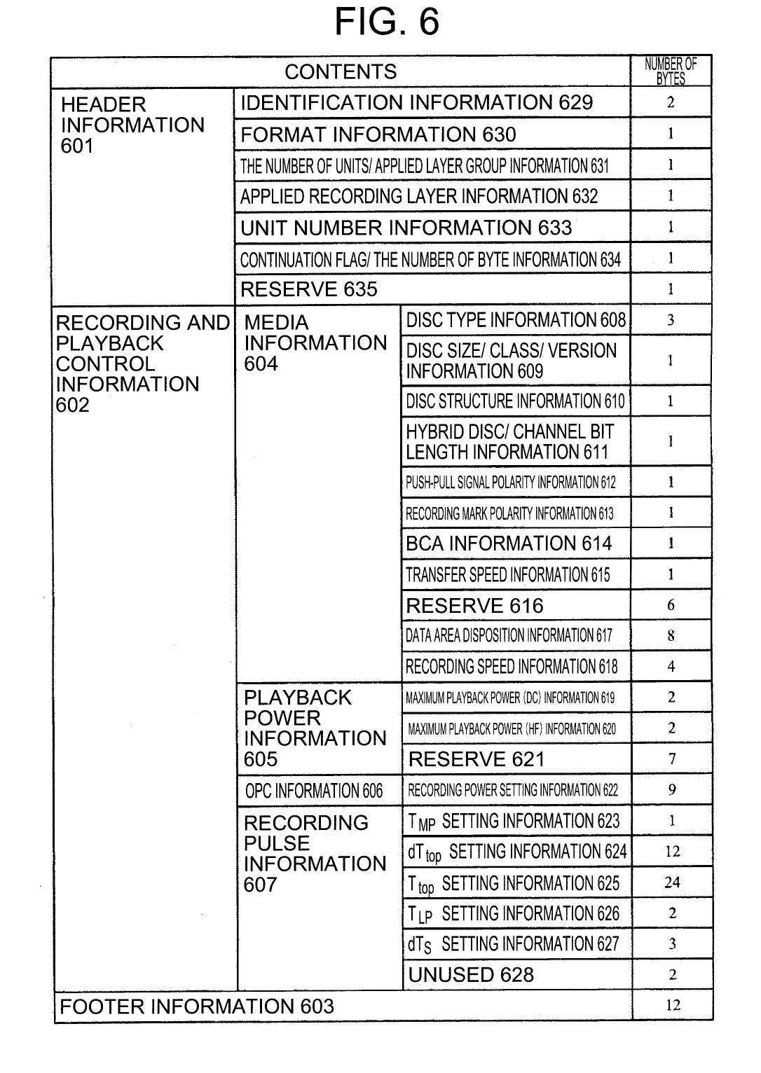

A configuration of each media control information unit will now be described with reference to FIG. 6. Each media control information unit is formed of data of 112 bytes in total including header information 601, recording and playback control information 602, and footer information 603.

The header information 601 is formed of parameters described hereafter. Identification information 629 indicates that the data unit is media control information. Format information 630 indicates a classification of contents of the media control information unit. The number of units/applied layer group information 631 indicates the number of kinds of media control information units and a layer group to which the media control information units are applied. Applied recording layer information 632 indicates recording layers to which the media control information unit is applied. Here, a layer group to which each of the recording layers belongs can be identified on the basis of information of the number of units/applied layer group information 631 and the applied recording layer information 632. Furthermore, the form of combination of the kind of the recording speed and the recording pulse classification shown in FIG. 9 is determined in advance by standards of the medium. An identification number for specifying this form is written in the format information 630. Therefore, it is made possible to know the number of layer groups as well by knowing the number of media control information units on the basis of information in the number of units/applied layer group information 631. Unit number information 633 indicates a series number of the media control information unit in the media control information area. Continuation flag/the number of byte information 634 indicates whether there is description of media control information extending over the next media control information unit and the number of bytes assigned in the media control information unit to recording and playback control information. Reserve 635 is a reservation parameter for future expansion, and all zero data is written provisionally.

Contents of the recording and playback control information 602 are divided into media information 604, playback power information 605, OPC information 606, and recording pulse information 607, and parameters relating to respective items are written. Information of the manufacturer of the medium and manufacture year and month of the medium is included in the footer information 603.

The media information 104 includes parameters described hereafter. Disc type information 608 indicates which of the rewritable type/incremental recording type is the classification of a recording layer to which the media control information is applied. Disc size/class/version information 609 indicates a diameter of the disc, a class of a disc format, and a version. Disc structure information 610 indicates the number of recording layers and a classification (rewritable type/incremental recording type/playback only type) of recording layers to which the media control information is applied. Hybrid disc/channel bit length information 611 indicates whether there is a CD-DVD layer and a channel bit length. Push-pull signal polarity information 612 indicates a polarity of a tracking error signal using a push-pull system. Recording mark polarity information 613 indicates which of “High-to-Low” (reflectance of a recording mark is less than that in unrecorded portions) and “Low-to-High” (reflectance of a recording mark is greater than that in unrecorded portions) represents characteristics of the recording mark. BCA information 614 indicates whether there is a BCA (Burst Cutting Area) code. Transfer speed information 615 indicates a maximum data transfer speed requested of an application. Reserve 616 is a reservation parameter similar to the reserve 635. Data area disposition information 617 indicates an address range of the data area in the recording layer. Recording speed information 618 indicates a range of the recording speed to which the media control information is applied.

The playback power information 605 is formed of parameters described hereafter. Maximum playback power (DC) information 619 indicates a maximum value of medium incident light power at the time when conducting playback using DC light at a recording speed to which the media control information unit is applied. This maximum playback power is determined to cause the quality of the played back signal to satisfy a predetermined reference value even after a recorded track is played back 10⁶ times. Maximum playback power (HF) information 620 indicates a maximum value of medium incident light power at the time when conducting playback using high frequency superposed light. Reserve 621 is a reservation parameter similar to the reserves 635 and 616.

The OPC information 606 is formed of recording power setting information 622 which indicates conditions at the time when executing the OPC. The recording power setting information 622 is formed of a specified recording power for executing OPC of the κ system P_{IND}, target modulation m_{IND}, coefficient ρ, bias power to peak power ratio ε_{BW}, cooling power to peak power ratio ε_{C}, space power to peak power ratio ε_{S}, coefficient target value κ, and asymmetry β for executing OPC of the β system.

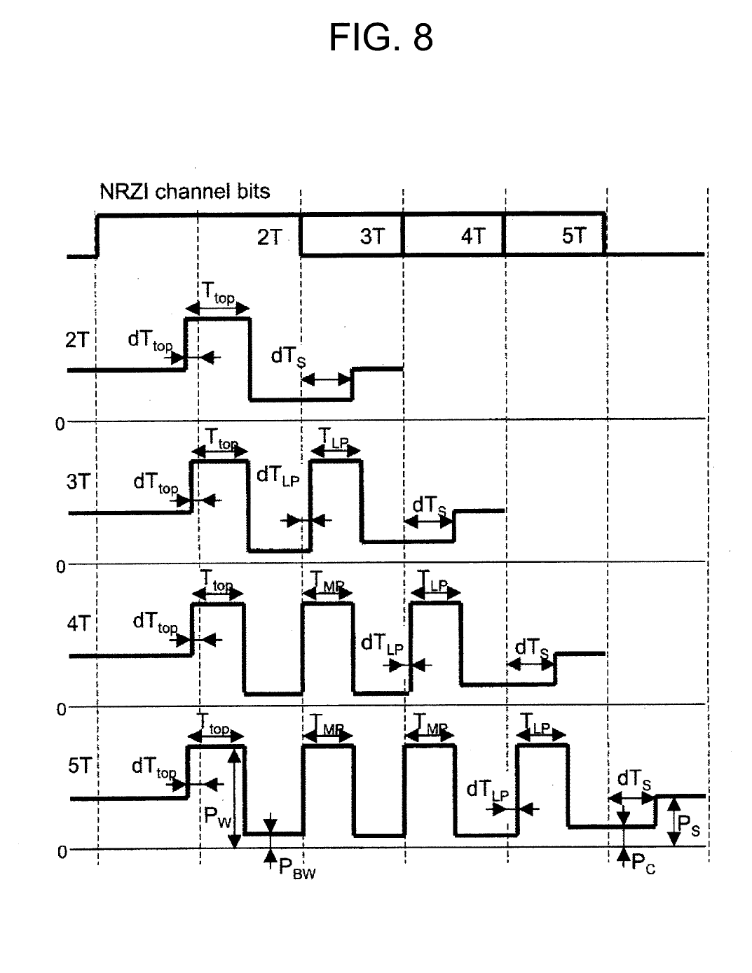

The recording pulse information 607 is formed of parameters that specify timing of recording pulses used at the time of recording. In the present embodiment, either “N−1 write strategy” or “Castle write strategy” can be used as the recording pulse classification. It is now assumed in the description that the “N−1 write strategy” shown in FIG. 8 is used. FIG. 8 shows recording pulse waveforms for forming 2T to 5T marks. Here, power level P_{W} is referred to as peak power, P_{BW} is referred to as bias power, P_{S} is referred to as space power, and P_{C} is referred to as cooling power. In the N−1 write strategy, there is one recording pulse having a peak power level in a case of a 2T mark. The number of recording pulses having a peak power level is two in a case of a 3T mark. Subsequently, the number of recording pulses having a peak power level increases by one each time 1T increases.

A first pulse having a peak power level included in a recording pulse train is referred to as top pulse. A last pulse having a peak power level is referred to as final pulse. A plurality of pulses having a peak power level between the top pulse and the final pulse are referred to as intermediate pulses. A recording pulse waveform in the N−1 write strategy is specified by a time width of intermediate pulses T_{MP}, start time of the top pulse dTₜₒₚ, time width of the top pulse Tₜₒₚ, time width of the final pulse T_{LP}, and end time of a cooling pulse dT_{S}. The recording pulse information 607 includes T_{MP} setting information 623, dTₜₒₚ setting information 624, Tₜₒₚ setting information 625, T_{LP} setting information 626, and dT_{S} setting information 627. A parameter area corresponding to unused 628 is not used. Parameter values of three ways in total, i.e., in a case where the length of the recording marks is 2T, a case where the length of the recording marks is 3T, and a case where the length of the recording marks is at least 4T, are written. As for the dTₜₒₚ setting information 624 and the Tₜₒₚ setting information 625, the length of the recording marks is classified into cases of 2T, 3T and at least 4T, and in addition the length of a space preceding the recording marks is classified into four cases of 2T, 3T, 4T and at least 5T, and parameter values of 3*4=12 ways are written. As for the T_{LP} setting information 626 and the dT_{S} setting information 627, parameter values of three ways in total, i.e., in a case where the length of the recording marks is 2T, a case where the length of the recording marks is 3T, and case where the length of the recording marks is at least 4T.

As regards each of representative parameters, a concrete description method of its value will now be described. As for the number of units/applied layer group information 631, the number of the media control information units is written in five high-order bits in 1 bite (8 bit) data assigned to this information, and a number of a layer group to which the media control information unit is applied is written in three low-order bits. For example, 000 is written if the layer group is the zero-th layer group, and 001 is written if the layer group is the first layer group.

As for the applied recording layer information 632, a range (a minimum value and a maximum value) of the layer number to which the media control information unit is applied is written in one byte assigned to this information. Specifically, for example, when the range of the layer number to which the media control information unit is applied is 3 to 7, a minimum value 0011 of the layer number is written in four high-order bits and a maximum value 0111 of the layer number is written in four low-order bits. As for the disc structure information 610, the total number of recording layers is written in four high-order bits of 1 byte data assigned to this information. For example, 0001 is written in case of one layer, and 1000 is written in case of eight layers. Furthermore, a classification of the recording layer to which the media control information is applied is written in four low-order bits. In case of the rewritable type/incremental recording type/playback only type, 0100/0010/0001 is written, respectively. Since the medium in the present embodiment is the incremental recording type, 0010 is written here.

The maximum playback power (DC) information 619 will now be described. It is now supposed that maximum playback power (unit is mW) generated by DC light irradiation of an nth recording layer is given by a first order function of the layer number n as represented by the following MATH. 5.

[MATH. 5]

Prₘₐₓ(n)=c₀+c₁n MATH. 5

At this time, an integer value i satisfying i=100*c₀ is written in first 1 byte in 2 byte data assigned to this information, in a sign-less 8 bit form. An integer value i satisfying i=1,000*c₁ is written in the next 1 byte in an 8 bit form of 2's complement representation. A concrete example will now be described. It is now supposed that the maximum playback power Prₘₐₓ(n) is given by the following MATH. 6.

[MATH. 6]

Prₘₐₓ(n)=1.42−0.062n MATH. 6

As for c₀, 100*1.42=142, and consequently “10001110” which is a binary number representation of 142 is written in a byte representing c₀. As for c₁, 1,000*(−0.062)=(−62), and consequently “11000010” which is a binary number representation (2's complement) of (−62) is written in a byte representing c₁. As for the maximum playback power (HF) information 620 as well, maximum playback power (unit is mW) generated by high frequency superposed light irradiation is written in a similar form. By the way, values of c₀ and c₁ are different every layer group. The above-described example is a concrete example in the case where the maximum playback power is given by a first order function of the layer number. In general, however, the same is also true of a case where the maximum playback power is given by an mth order function of the layer number n as represented by the following MATH. 11.

[MATH. 11]

Prₘₐₓ(n)=c₀+c₁n+c₂n²+Λ+cₘ₋₁n^{m-1}+cₘn^{m} MATH. 11

In this case, the configuration of the media control information unit is changed to assign data of (m+1) bytes to each of the maximum playback power (DC) information 619 and the maximum playback power (HF) information 620. And integer values indicating values of c₀, c₁, c₂, . . . , Cₘ₋₁, cₘ are written in respective bytes of (m+1) byte data.

The recording power setting information 622 will now be described. A specified recording power (unit is mW) for the nth recording layer is written in first 2 bytes in 8 byte data assigned to this information. It is now supposed that the specified recording power is given by a first order function of the layer number n as represented by the following MATH. 7.

[MATH. 7]

P_{IND}(n)=c₀+c₁n MATH. 7

At this time, an integer value i satisfying i=100*c₀ is written in first 1 byte in 2 byte, in a sign-less 8 bit form. An integer value i satisfying i=1,000*c₁ is written in the next 1 byte in an 8 bit form of 2's complement representation. By the way, values of c₀ and c₁ are different every layer group. An integer value i satisfying i=200*m_{IND}, an integer value i satisfying i=100*ρ, an integer value i satisfying i=200*ε_{BW}, an integer value i satisfying i=200*ε_{C}, an integer value i satisfying i=200*ε_{S}, an integer value i satisfying i=20*κ, and an integer value i satisfying i=500*(β+0.2) are written respectively in remaining 7 bytes assigned to the recording power setting information 622, at a rate of one byte per value. The above-described example is a concrete example in the case where the specified recording power is given by a first order function of the layer number. In general, however, the same is also true of a case where the specified recording power is given by an mth order function of the layer number n as represented by the following MATH. 12.

[MATH. 12]

Pr_{IND}(n)=c₀+c₁n+c₂n²+Λ+cₘ₋₁n^{m-1}+cₘn^{m} MATH. 12

In this case, the configuration of the media control information unit is changed to assign data of (m+8) bytes to the recording power setting information 622. And integer values indicating values of c₀, c₁, C₂, . . . , Cₘ₋₁, cₘ are written in first (m+1) bytes in the (m+8) bytes.

As for parameters other than those mentioned above as well, parameter values are written by using a similar method, although contents and description forms of parameter values are respectively different.

### Embodiment 3

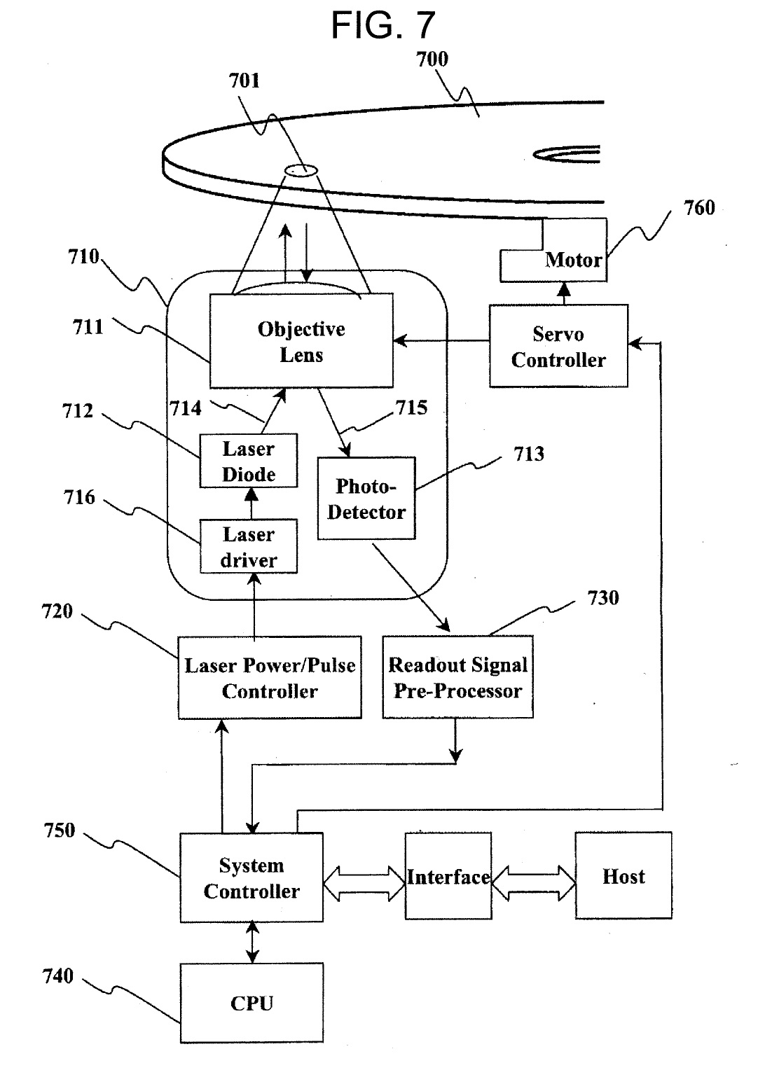

A configuration example of an optical disc device suitable for embodying the present invention will now be described with reference to FIG. 7. A multilayer optical disc medium 700 mounted on the device is rotated by a spindle motor 760. At the time of playback, a laser power/pulse controller 720 controls a current so as to flow through a semiconductor laser 712 via a laser driver 716 in an optical head 710 to attain a light intensity ordered by a CPU 740, and causes the semiconductor laser 712 to generate laser light 714. The laser light 714 is focused by an objective lens 711 to form an optical spot 701 on some recording layer in the multilayer optical disc medium 700. At this time, spherical aberration is corrected according to a thickness from a light incidence face of the multilayer optical disc medium 700 to a recording layer in which the optical spot 701 is formed, by a spherical aberration correction mechanism which is disposed between the semiconductor laser 712 and the objective lens 711 and which is not illustrated. Reflected light 715 from the optical spot 701 is detected by a photodetector 713 via the objective lens 711. The photodetector includes a photodetector element divided into a plurality of portions. A readout signal pre-processor 730 reads out information recorded on the multilayer optical disc medium 700 by using a signal detected by the optical head 710. The whole device including them is controlled by a system controller 750.

### Embodiment 4

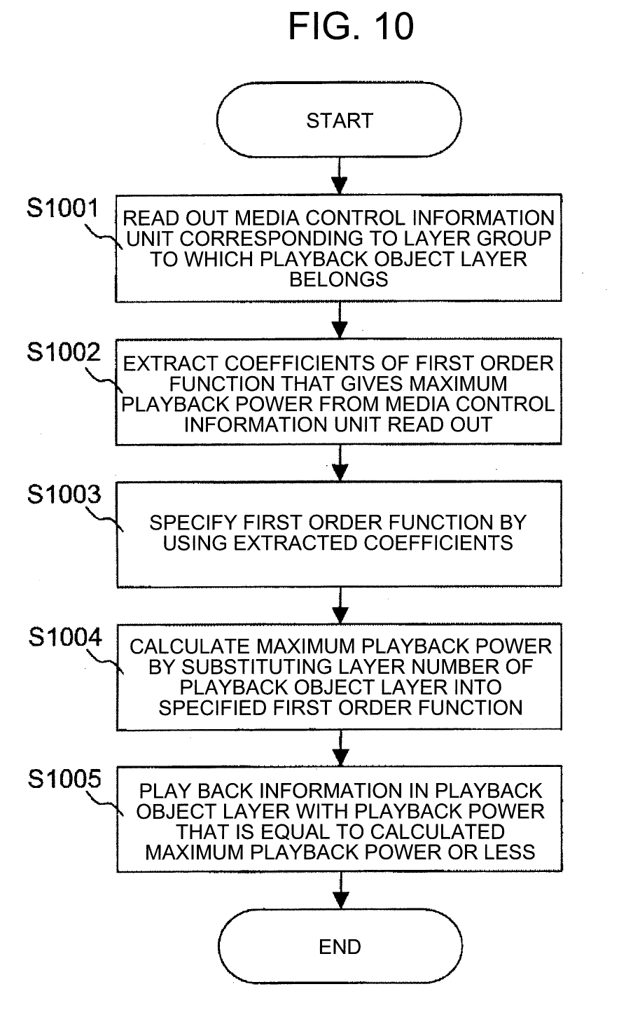

A concrete example of an information readout method using the multilayer optical disc medium according to the present invention will now be described. FIG. 10 is a flow chart showing one form of an information playback procedure in the present embodiment. In the present embodiment, it is supposed to use a medium in which recording layers are classified into layer groups, media control information for each of the recording layers is given for every layer group, maximum playback power for each of the recording layers is given by a polynomial function, and parameters indicating respective coefficients of the polynomial function are written in the media control information, as in the multiplayer optical disc medium in the embodiment 2. In the ensuing description, it is supposed that the polynomial function that gives maximum playback power is a first order function as in the optical disc medium in the embodiment 2.

First, at step S1001, a media control information unit corresponding to the combination of a layer group to which a recording layer (playback object layer) to be played back belongs and a playback speed is selected and read out from the media control information area 505 shown in FIG. 5 in some recording layer in the multilayer optical disc medium, by referring to the correspondence relations shown in FIG. 9. Since media control information for all recording layers is written in all recording layers in the multilayer optical disc medium in the embodiment, necessary information can be read out from any recording layer.

Subsequently at step S1002, parameters indicating coefficients c₀ and c₁ of the following MATH. 8 which is a first order function of a layer number that gives the maximum playback power are extracted from the media control information unit read out.

[MATH. 8]

Prₘₐₓ(n)=c₀+c₁n MATH. 8

These parameters are written in either the maximum playback power (DC) information 619 or the maximum playback power (HF) information 620 shown in FIG. 6. Selection as to which information is to be used is conducted according to the laser drive condition at the time of playback (either DC light or high frequency superposed light).

Subsequently, at step S1003, the first order function of the layer number n is specified by using the extracted coefficients c₀ and c₁.

Subsequently, at step S1004, maximum playback power Prₘₐₓ(n) for the playback object layer is calculated by substituting a layer number n of the playback object layer into the specified first order function of the layer number n. At this time, maximum playback power can also be calculated for remaining recording layers that belong to the same layer group as the playback object layer by using the same method.

Finally, at step S1005, a control target value of playback power is set equal to a magnitude that does not exceed the calculated maximum playback power, and information in the playback object layer is played back. Here, it is also possible to take a control error of playback power in the recording and playback device into consideration and set the control target value to a value that is lower by that amount in order to prevent the maximum playback power from being exceeded during the playback.

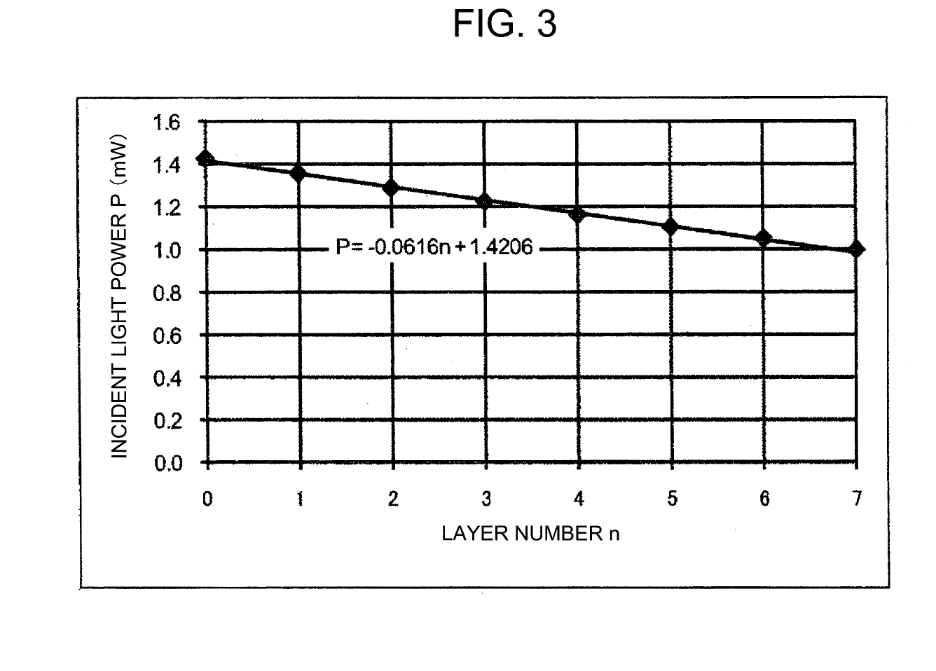

The present embodiment is a concrete example in the case where the maximum playback power is given by a first order function of the layer number. In the case of a polynomial function (mth order function) other than the first order function as well, however, the same procedure can be applied except that the number of coefficients written in the media control information becomes (m+1). Specifically, at the step S1002, coefficients c₀, c₁, . . . , Cₘ₋₁, cₘ of the mth order function of the layer number giving the maximum playback power are extracted. At the step S1003, the mth order function of the layer number is specified by using the extracted coefficients. At the step S1004, maximum playback power Prₘₐₓ(n) for the playback object layer is calculated by substituting a layer number n of the playback object layer into the specified mth order function of the layer number. The procedure other than this is the same. The precision of the maximum playback power calculated from the polynomial function can be improved by using the polynomial function which is greater in degree than the first order function in this way. For example, in a case where the relation between the layer number and the incident light power shown in FIG. 3 is approximated by using a first order function as described above, a maximum error is 1.1%. On the other hand, the maximum error becomes 0.12% in a case where the relation is approximated by using a second order function.

### Embodiment 5

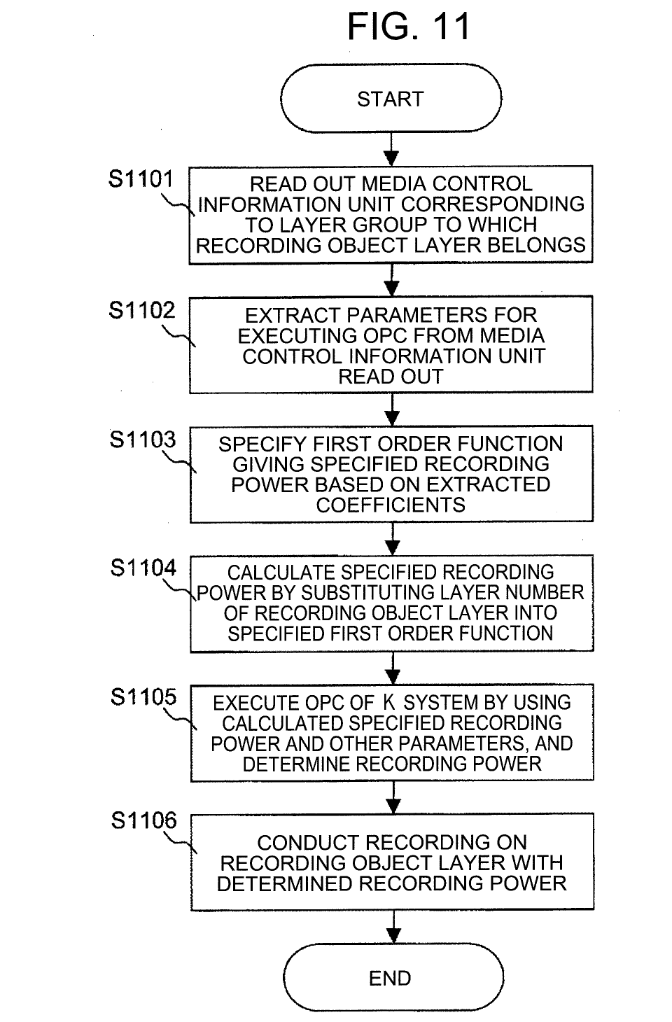

A concrete example of an information recording method using a multilayer optical disc medium according to the present invention will now be described. FIG. 11 is a flow chart showing one form of an information recording procedure in the present embodiment. In the present embodiment, it is supposed to use a medium in which recording layers are classified into layer groups, media control information for each of the recording layers is given for every layer group, parameters for executing OPC on each of the recording layers are written, specified recording power included in the parameters is given by a polynomial function of the layer number, and parameters indicating respective coefficients of the polynomial function are written in the media control information, as in the multiplayer optical disc medium in the embodiment 2. In the ensuing description, it is supposed that the polynomial function that gives a specified recording power is a first order function as in the optical disc medium in the embodiment 2. In the case of a polynomial function other than the first order function as well, only the number of coefficients written in the media control information is different, and consequently the same procedure can be applied.

First, at step S1001, a media control information unit corresponding to the combination of a layer group to which a recording layer (recording object layer) to be recorded belongs, a recording speed, and a recording pulse classification to be used is selected and read out from the media control information area 505 shown in FIG. 5 in some recording layer in the multilayer optical disc medium, by referring to the corresponding relations shown in FIG. 9. Since media control information for all recording layers is written in all recording layers in the multilayer optical disc medium in the embodiment, necessary information can be read out from any recording layer.

Subsequently at step S1102, parameters indicating coefficients c₀ and c₁ of the following MATH. 9 which is a first order function of a layer number that gives the specified recording power,

[MATH. 9]

Pr_{IND}(n)=c₀+c₁n MATH. 9

target modulation m_{IND}, coefficient ρ, bias power to peak power ratio ε_{BW}, cooling power to peak power ratio ε_{C}, space power to peak power ratio ε_{S}, and coefficient target value κ are respectively extracted from the media control information unit read out.

Subsequently, at step S1103, the first order function of the layer number n is specified by using the extracted coefficients c₀ and c₁.

Subsequently, at step S1104, a specified recording power P_{IND}(n) for the recording object layer is calculated by substituting a layer number n of the recording object layer into the specified first order function of the layer number n. At this time, a specified recording power can also be calculated for remaining recording layers that belong to the same layer group as the recording object layer does by using the same method. Furthermore, m_{IND}, ρ, ratios ε_{BW}, ε_{C}, and ε_{S}, and κ extracted at the step 1102 can be used in common with remaining recording layers that belong to the same layer group as the recording object layer.

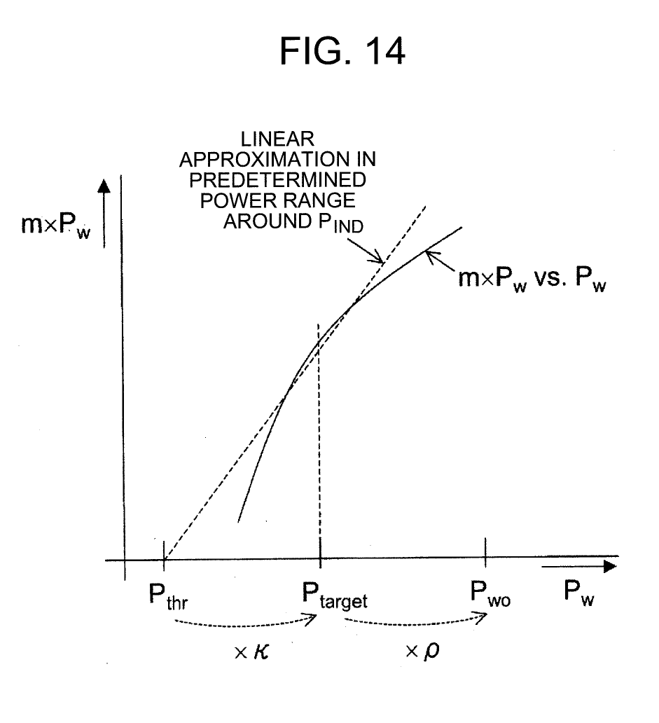

Subsequently, at step S1105, OPC of the κ system is executed in the OPC area 506 of the recording object layer on the basis of the extracted parameters, and a recording power is determined. Specifically, calculation of the optimum recording power P_{WO} is conducted by using the relation between the recording power P_{W} and the modulation m, and P_{IND}, κ, and ρ. Here, target modulation m_{IND} is a reference value related to P_{IND} as a modulation m at the time when P_{W}=P_{IND}. The target modulation m_{IND} is not used in OPC in the present embodiment. A calculation method of the optimum recording power will now be described with reference to FIG. 14. First, a predetermined signal is recorded in the OPC area 506 shown in FIG. 5 by using the recording power P_{W} of a plurality of kinds in the vicinity of the specified recording power P_{IND}, and the recorded signal is played back. As a result, the modulation m which is a value obtained by dividing an amplitude of a played back signal by an upper envelope level is acquired in association with the recording power P_{W}. Subsequently, linear approximation is conducted on a relation between an evaluated value m*P_{W} and the recording power P_{W} in a predetermined power range around P_{IND}. A value of the recording power P_{W} in a case where the evaluated value m*P_{W} becomes zero is calculated as recording power threshold Pₜₕᵣ. In a relation between a target recording power P_{target}=Λ*Pₜₕᵣ obtained by multiplying the calculated Pₜₕᵣ by the coefficient target value κ and the recording power P_{W}, recording power P_{W} satisfying P_{target}=P_{W} is determined as optimum target recording power P_{tageto}. A value obtained by multiplying the optimum target recording power P_{targeto} by the coefficient ρ is determined as an optimum recording power P_{WO}.

Finally, at step S1106, the determined recording power is set and information is recorded in the recording object layer.

The present embodiment is a concrete example in the case where the specified recording power is given by a first order function of the layer number. In the case of a polynomial function (mth order function) other than the first order function as well, however, the same procedure can be applied except that the number of coefficients written in the media control information becomes (m+1). Specifically, at the step S1102, coefficients c₀, c₁, . . . , Cₘ₋₁, cₘ of the mth order function of the layer number giving the specified recording power are extracted. At the step S1103, the mth order function of the layer number is specified by using the extracted coefficients. At the step S1104, a specified recording power Pr_{IND}(n) for the recording object layer is calculated by substituting a layer number n of the playback object layer into the specified mth order function of the layer number n. The procedure other than this is the same. The precision of the specified recording power calculated from the polynomial function can be improved by using the polynomial function which is greater in degree than the first order function in this way.

### Embodiment 6

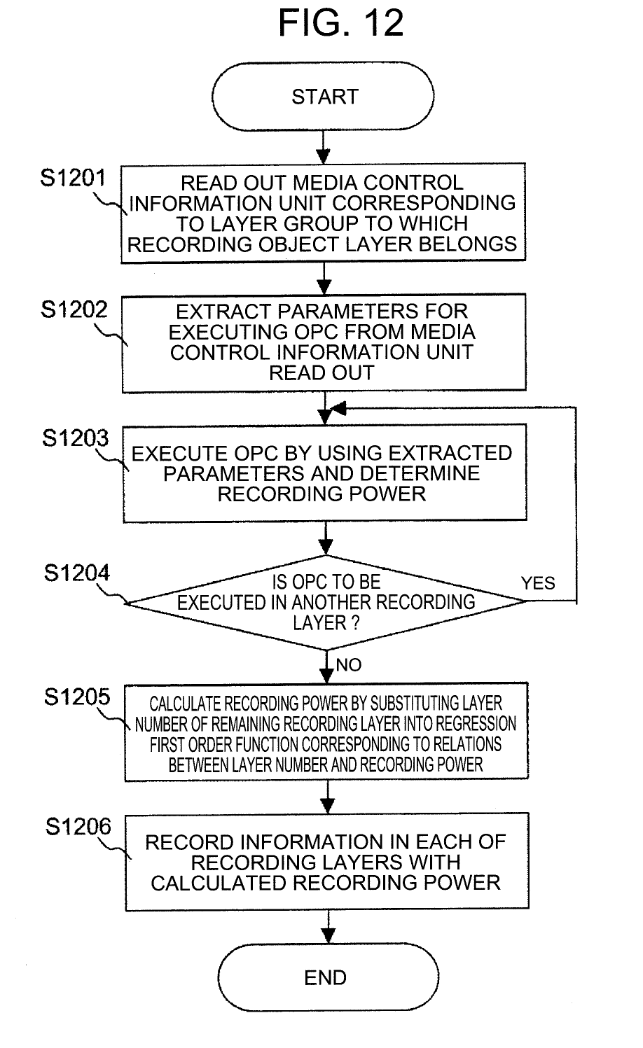

Another example of the information recording method using the multilayer optical disc medium according to the present invention will now be described. FIG. 12 is a flow chart showing one form of an information recording procedure in the present embodiment. In the present embodiment, it is supposed to use a medium in which a specified recording power is given by a first order function of the layer number, and parameters indicating respective coefficients of the first order function are written in the media control information, as in the multiplayer optical disc medium in the embodiment 2.

First, at step S1201, a media control information unit corresponding to the combination of a layer group to which a recording layer (recording object layer) to be recorded belongs, a recording speed, and a recording pulse classification to be used is selected and read out from the media control information area 505 shown in FIG. 5 in some recording layer in the multilayer optical disc medium, by referring to the corresponding relations shown in FIG. 9.

Subsequently at step S1202, parameters for executing OPC are extracted from the media control information unit read out. The parameters read out here are basically parameters for executing OPC of the κ system in the same way as the embodiment 5. Instead, however, a parameter indicating asymmetry β for executing OPC of the β system can also be extracted. In that case, OPC of the β system is executed in subsequent steps.

Subsequently, at step S1203, OPC is executed in the OPC area 506 in the recording object layer by using the extracted parameters and recording power is determined. Here, the κ system may be used as the OPC in the same way as the embodiment 5, or instead the β system may be used. In that case, supposing that an upper envelope level of an AC-coupled played back signal is A1 and a lower envelope level thereof is A2, a recording power is determined to cause β represented by β=(A1+A2)/(A1−A2) to become equal to the extracted parameter value.

Subsequently, at step S1204, it is determined whether to execute OPC in another recording layer that belongs to the same layer group as the recording layer subjected to OPC. In a case where OPC is to be executed in another recording layer (Yes), the processing returns to step S1203, OPC is executed in another recording layer, and a recording power for the recording layer is determined. In a case where no more OPC is executed in the determination at the step S1204 (No), the processing proceeds to step S1205. However, OPC must be executed in at least two recording layers belonging to the same layer group.

At step S1205, a regression first order function corresponding to relations between the layer number and determined recording power is found on the basis of a result of OPC executed in a plurality of recording layers. A recording power for a remaining recording layer that belongs to the same layer group as the recording layer subjected to OPC is calculated by substituting a layer number of the remaining recording layer into the found regression first order function.

Finally, at step S1206, in each of the recording layers, a recording power determined for the recording layer is set and information is recorded.

### Embodiment 7

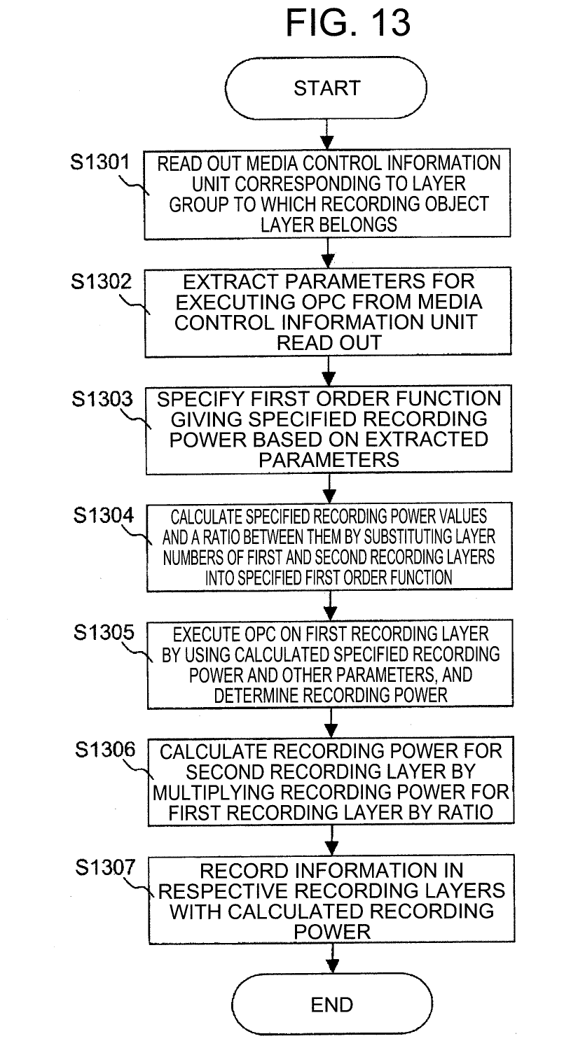

Another example of the information recording method using the multilayer optical disc medium according to the present invention will now be described. FIG. 13 is a flow chart showing one form of an information recording procedure in the present embodiment. In the present embodiment, it is supposed to use a medium in which a parameter indicating a specified recording power is written in the media control information. In the ensuing description, it is supposed to use a medium in which a specified recording power is given by a first order function of the layer number, and parameters indicating respective coefficients of the first order function are written in the media control information, as in the multiplayer optical disc medium in the embodiment 2.

First, at step S1301, a media control information unit corresponding to the combination of a layer group to which a recording layer (recording object layer) to be recorded belongs, a recording speed, and a recording pulse classification to be used is selected and read out from the media control information area 505 shown in FIG. 5 in some recording layer in the multilayer optical disc medium, by referring to the corresponding relations shown in FIG. 9.

Subsequently at step S1302, parameters indicating coefficients c₀ and c₁ of the following MATH. 10 which is a first order function of a layer number that gives the specified recording power,

[MATH. 10]

Pr_{IND}(n)=c₀+c₁n MATH. 10

target modulation m_{IND}, coefficient ρ, bias power to peak power ratio ε_{BW}, cooling power to peak power ratio ε_{C}, space power to peak power ratio ε_{S}, and coefficient target value κ are respectively extracted from the media control information unit read out. In a case where the β system is used when executing subsequent OPC, a parameter indicating asymmetry β is also extracted at this time. In that case as well, however, it is necessary to extract a parameter indicating the specified recording parameter P_{IND} at this time.

Subsequently, at step S1303, the first order function of the layer number n is specified by using the extracted coefficients c₀ and c₁.

Subsequently, at step S1304, a specified recording power P_{IND}(n1) for a first recording layer is calculated by substituting a layer number n1 of the first recording layer into the specified first order function of the layer number n. Furthermore, a specified recording power P_{IND}(n2) for a second recording layer that belongs to the same layer group as the first recording layer does is calculated by substituting a layer number n2 of the second recording layer into the same first order function. In addition, a ratio of the specified recording power for the second recording layer to the recording power for the first recording layer α=Pn(n2)/P_{IND}(n1) is calculated.

Subsequently, at step S1305, OPC is executed in the OPC area 506 of the first recording layer by using the extracted parameters, and a recording power P_{WO1} for the first recording layer is determined. Here, the κ system may be used as the OPC in the same way as the embodiment 5, or instead the β system may be used.

Subsequently, at step S1306, a recording power P_{WO2} for the second recording layer is calculated by multiplying the recording power P_{WO1} for the first recording layer determined at the step S1305 by the ratio α.

Finally, at step S1307, information is recorded by using the recording power P_{WO1} in the first recording layer and the recording power P_{WO2} in the second recording layer.

The present embodiment is a concrete example in the case where the specified recording power is given by a first order function of the layer number. In the case of a polynomial function (mth order function) other than the first order function as well, however, the same procedure can be applied except that the number of coefficients written in the media control information becomes (m+1). Specifically, at the step S1302, coefficients c₀, c₁, . . . , cₘ₋₁, Cₘ of the mth order function of the layer number giving the specified recording power are extracted. At the step S1303, the mth order function of the layer number is specified by using the extracted coefficients. At the step S1304, a specified recording power Pr_{IND}(n1) for the first recording layer is calculated by substituting the layer number n1 of the first recording layer into the specified mth order function of the layer number n. A specified recording power Pr_{IND}(n2) for the second recording layer is calculated by substituting the layer number n2 of the second recording layer into the same mth order function. The procedure other than this is the same. The precision of the specified recording power calculated from the polynomial function can be improved by using the polynomial function which is greater in degree than the first order function in this way.

Embodiments of the present invention are not restricted to the above-described embodiments. In the above-described embodiments, a multilayer optical disc medium has been mentioned as an application example of the multilayer optical information recording medium according to the present invention. However, the application example of the multilayer optical information recording medium is not restricted to the multilayer optical disc medium. The multilayer optical information recording medium according to the present invention may be applied to other media as long as the medium has a plurality of stacked recording layers and recording and playback of information are conducted by light irradiation. For example, similar effects can be obtained by applying the present invention to a groove-less multilayer optical disc media including a plurality of recording layers that do not have a guide groove and a guide layer which is dedicated to tracking and which has a guide groove, non-rotating card media, tape-shaped media, or the like. In addition, as for the so-called volume recording medium having no recording layers in the medium and recording areas are formed in a plane form at various depths from the medium surface as well, it is a multilayer optical information recording medium in a broad sense if the plane-formed recording areas are regarded as recording layers. Therefore, the present invention can be applied to the so-called volume recording media in the same way. Furthermore, as for the way of assigning layer numbers to the recording layers, serial numbers extending over the whole medium are used in the above-described embodiments. However, the way of assigning layer numbers is not restricted to this. Even if serial numbers are used every layer group like a zero-th layer, a first layer, . . . in a zero-th layer group and a zero-th layer, a first layer, . . . in a first layer group, effects of the present invention can be obtained in the same way. Furthermore, as for the contents of the media control information and the parameter value description method as well, configurations other than those in the above-described embodiments may be used.

### REFERENCE SIGNS LIST

201: Header
202: Main body
203: Footer
401: Multilayer optical disc medium
402: Substrate
403: zero-th recording layer
404: Intermediate layer
405: First recording layer
406: Intermediate layer
407: Second recording layer
408: Intermediate layer
409: Third recording layer
410: Intermediate layer
411: Fourth recording layer
412: Intermediate layer
413: Fifth recording layer
414: Intermediate layer
415: Sixth recording layer
416: Intermediate layer
417: Seventh recording layer
418: Cover layer
501: Multilayer optical disc medium
502: Lead-in area
503: Data area
504: Lead-out area
700: Multilayer optical disc medium
701: Optical spot
710: Optical head
711: Objective lens
712: Semiconductor laser
713: Photodetector
714: Laser light
715: Reflected light
716: Laser driver
720: Laser power/pulse controller
730: Readout signal pre-processor
740: CPU
750: System controller
760: Spindle motor

1. A multilayer optical information recording medium comprising:
at least three recording layers, the recording layers being classified into layer groups that are fewer in number than the recording layers, and media control information common in a layer group being provided every layer group generated by the classification; and
an administration area where the media control information provided for every layer group is recorded.

2. The multilayer optical information recording medium according to claim 1, wherein
the media control information comprises parameters for specifying maximum playback power with respect to each of the recording layers belonging to the layer group, and
the parameters are different for every layer group.

3. The multilayer optical information recording medium according to claim 2, wherein
the recording layers are respectively provided with consecutive integer layer numbers in order from back when viewed from a light incidence plane of the multilayer optical information recording medium or in order from front,
the maximum playback power for each of the recording layers is given by a polynomial function of the layer number, and
parameters for specifying maximum playback power for each of the recording layers are parameters indicating respective coefficients of the polynomial function of the layer number.

4. The multilayer optical information recording medium according to claim 3, wherein
the polynomial function of the layer number is a first order function of the layer number.

5. The multilayer optical information recording medium according to claim 1, wherein
the media control information comprises parameters for executing OPC on each of the recording layers, and
the parameters are different for every layer group.

6. The multilayer optical information recording medium according to claim 5, wherein
the parameters for executing OPC comprise at least specified recording power for executing OPC of a κ system,
the recording layers are respectively provided with consecutive integer layer numbers in order from back when viewed from a light incidence plane of the multilayer optical information recording medium or in order from front,
the specified recording power for each of the recording layers is given by a polynomial function of the layer number, and
parameters for specifying specified recording power for each of the recording layers are parameters indicating respective coefficients of the polynomial function of the layer number.

7. The multilayer optical information recording medium according to claim 6, wherein
the polynomial function of the layer number is a first order function of the layer number.

8. The multilayer optical information recording medium according to claim 1, wherein
the media control information comprises parameters indicating timing of recording pulses, and
the parameters are different every layer group.

9. The multilayer optical information recording medium according to claim 1, wherein
the media control information comprises parameters for specifying a layer group to which each of the recording layers belongs.

10. The multilayer optical information recording medium according to claim 4, wherein
all recording layers belonging to same layer group are formed of substantially same film configuration.

11. An information playback method comprising:
a process for reading out media control information corresponding to a layer group to which a playback object layer belongs, from a multilayer optical information recording medium comprising at least three recording layers, the recording layers being classified into layer groups that are fewer in number than the recording layers, media control information common in a layer group being recorded every layer group generated by the classification, and the media control information comprising parameters for specifying maximum playback power for each of the recording layers;
a process for extracting parameters for specifying maximum playback power for the playback object layer from the media control information read out;
a process for specifying maximum playback power for the playback object layer by using the extracted parameters; and
a process for playing back information of the playback object layer with playback power that does not exceed the specified maximum playback power.

12. The information playback method according to claim 11, wherein
the recording layers are respectively provided with consecutive integer layer numbers in order from back when viewed from a light incidence plane of the multilayer optical information recording medium or in order from front, the maximum playback power for each of the recording layers is given by a polynomial function of the layer number, and parameters for specifying maximum playback power for each of the recording layers are parameters indicating respective coefficients of the polynomial function of the layer number,
the process for extracting parameters is a process for extracting parameters indicating respective coefficients of the polynomial function of the layer number for the playback object layer from the media control information read out, and
the process for specifying maximum playback power is a process for specifying a polynomial function of the layer number by using the extracted parameters and calculating maximum playback power for the playback object layer by substituting the layer number of the playback object layer into the polynomial function of the layer number.

13. An information recording method comprising:
a process for reading out media control information corresponding to a layer group to which a recording object layer belongs, from a multilayer optical information recording medium comprising at least three recording layers, the recording layers being classified into layer groups that are fewer in number than the recording layers, media control information common in a layer group being recorded every layer group generated by the classification, and the media control information comprising parameters for executing OPC on each of the recording layers;
a process for extracting parameters for executing OPC on the recording object layer from the media control information read out;
a process for conducting the OPC in the recording object layer by using the extracted parameters and determining recording power for the recording object layer; and
a process for recording information in the recording object layer by using the determined recording power.

14. The information recording method according to claim 13, wherein
the parameters for executing OPC comprise at least specified recording power for executing OPC of a κ system, the recording layers are respectively provided with consecutive integer layer numbers in order from back when viewed from a light incidence plane of the multilayer optical information recording medium or in order from front, the specified recording power for each of the recording layers is given by a polynomial function of the layer number, and parameters for specifying specified recording power for each of the recording layers are parameters indicating respective coefficients of the polynomial function of the layer number,
the process for extracting parameters is a process for extracting parameters indicating respective coefficients of the polynomial function, and
the process for determining recording power is a process for specifying the polynomial function from the extracted parameters, calculating specified recording power for the recording object layer by substituting the layer number of the recording object layer into the specified polynomial function, executing OPC of the κ system in the recording object layer by using the calculated specified recording power, and determining recording power for the recording object layer.

15. The information recording method according to claim 14, wherein
a function of the layer number is a first order function of the layer number,
the information recording method comprising:
a process for executing OPC in each of at least two recording layers among recording layers belonging to same layer group, and determining recording power for each of the recording layers;
a process for calculating a regression first order function corresponding to relations between the layer number of the recording layer for which the OPC is executed and determined recording power; and
a process for determining recording power for a different recording layer belonging to same layer group as the recording layer for which the OPC is executed does, by substituting a layer number of the different recording layer into the calculated regression first order function.

16. The information recording method according to claim 13, wherein
the parameters for executing OPC comprise parameters indicating at least specified recording power for executing OPC of a κ system,
referring to one of the recording layers as first recording layer and referring to another recording layer that belongs to same layer group as the first recording layer as second layer,
the information recording method comprises:
a process for specifying specified recording power for each of the first recording layer and the second recording layer by using the parameters indicating the specified recording power;
a process for executing OPC in the first recording layer and determining recording power for the first recording layer;
a process for calculating a ratio of specified recording power for the second recording layer to the specified recording power for the first recording layer; and
a process for determining recording power for the second recording layer by multiplying the determined recording power for the first recording layer by the calculated ratio.

17. The multilayer optical information recording medium according to claim 7, wherein
all recording layers belonging to same layer group are formed of substantially same film configuration.

18. The multilayer optical information recording medium according to claim 8, wherein
all recording layers belonging to same layer group are formed of substantially same film configuration.
